(19) United States
(12) Patent Application Publication
(10) Pub. No.: US 2025/0206468 A1
(43) Pub. Date: Jun. 26, 2025

(54) Modular Deployable Space Structure

(71) Applicant: L'Garde, Inc., Tustin, CA (US)

(72) Inventor: Arthur Libornio Palisoc, Tustin, CA (US)

(21) Appl. No.: 19/065,037

(22) Filed: Feb. 27, 2025

Related U.S. Application Data
(63) Continuation of application No. PCT/US2023/075274, filed on Sep. 27, 2023.
(60) Provisional application No. 63/377,345, filed on Sep. 27, 2022.

(51) Int. Cl. B64G 1/22

(52) U.S. Cl. CPC B64G 1/2221; B64G 1/223

(57) ABSTRACT

Systems and methods described herein include collapsible and deployable structures that may be used as antenna, collectors, reflectors, or other large structures. The systems and methods may use modular designs so that larger structures may be obtained for space applications.

### PRIORITY

The instant application claims priority as a continuation to International Application Number PCT/US2023/075274, filed Sep. 27, 2023, published as WO 2024/073514, which claims priority to U.S. Provisional Application No. 63/377,345, filed Sep. 27, 2022, each of which are incorporated by reference in their entirety herein.

### BACKGROUND

Antennas, especially for space applications, are desired to be lightweight and stowable into as small a stowage space as possible. The main reason is cost: the lighter and the smaller the space payload is, the lower the cost of launching it to space. For Antennas, aperture size is everything. The larger the aperture, the higher the antenna gain, efficiency and for imaging applications, the higher the resolution. There is, therefore, a direct collision between these competing interests.

### SUMMARY

Batten-less trusses described herein provide a collapsible structure that reduces the storage volume for deployable structures. Exemplary embodiments may include structures for use as a perimeter truss for reflector antennas and/or solar concentrators.

Exemplary embodiments include a truss comprising an assembly of members such as longerons, connected by nodes, that create a rigid structure when deployed. Exemplary embodiments of the batten-less trusses may include longerons that are collapsible between nodes. The longerons may be hinged, comprise a shape memory composite, or include other deformable material.

Exemplary embodiments described herein include combinations of the batten-less trusses in modular sections to create a larger deployed system from smaller deployable sections.

### DRAWINGS

FIGS. 1A-1C illustrate an exemplary application of an antenna using a collapsible truss frame.

FIGS. 2A-2C illustrate an exemplary truss frame through the steps of expanding from a collapsed configuration to a deployed configuration according to embodiments described herein.

FIGS. 3A-3B illustrate an exemplary deployment system for use in the batten-less truss system according to embodiments described herein.

FIGS. 4A-4C illustrate exemplary support structures comprising exemplary embodiments of the batten-less truss according to embodiments described herein.

FIG. 5A illustrates an exemplary modular structure according to embodiments described herein in a completed configuration. FIG. 5B illustrates the exemplary module structure of FIG. 5A in an exploded view in which a modular piece is separated from the whole. FIG. 5C illustrates the removed modular piece from FIG. 5B.

FIG. 6 illustrates an exemplary wedge portion of the modular construction comprising a first substructure, a second substructure, and a third substructure comprising two parts.

FIGS. 7A-7C illustrate different elements of the substructure according to embodiments described herein.

FIG. 8 illustrates an embodiment of how two substructures of a larger superstructure may be joined together.

FIG. 9 illustrates an exemplary portion of the attachment panels according to an exemplary embodiment.

FIGS. 10A-10E illustrate an exemplary attachment method according to embodiments described herein.

FIGS. 11A-11C illustrate an exemplary attachment method according to embodiments described herein.

FIG. 12 illustrates an exemplary tessellated reflective surface of an exemplary solar collector according to embodiments described herein with FIG. 12A being an expanded view of a single reflective portion of the reflective surface.

FIG. 13 illustrates an exemplary individual piece wise reflective member within a portion of the support structure of the tessellated reflective surface according to embodiments described herein.

### DESCRIPTION

The following detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. The drawings are diagrammatic and schematic representations of exemplary embodiments of the invention and are not limiting of the present invention nor are they necessarily drawn to scale.

Exemplary embodiments of the systems and methods described herein make possible the construction of very large antenna apertures through a design that divides up the large diameter antenna structure into sub-truss antenna structures. When these sub-truss antenna structures are packaged and folded, these sub-structures may be configured to fit within the fairing of rocket boosters. The associate costs of deployment may therefore be managed by permitting a large area antenna to be formed with modular pieces that fit within more conventional and smaller load areas for easier and piece-wise deployment.

Exemplary embodiments described herein include a method of deploying a large aperture antenna structure using sub-antenna structures. In an exemplary embodiment, a method may include providing a plurality of sub-antenna structures, such as those described herein. Each of the sub-antenna structures may then be launched into orbit. The sub-antenna structures may be launched separately and/or together in one or more payloads on one or more launches (rockets). Once all of the plurality of sub-antenna structures are in orbit, the plurality of sub-antenna structure may be assembled into one large antenna that would otherwise not fit into even the largest booster fairing currently available. For example, antenna structures may event include an antenna diameter approaching a kilometer. In an exemplary embodiment of the method, a co-orbiting assembler robot may be used to join the plurality of sub-antenna structures into one large structure.

Although embodiments of the invention may be described and illustrated herein in terms of specific support structure, embodiments of this invention are not so limited but are additionally applicable to different configurations. Exemplary embodiments also disclosed herein include different combinations of deformable options as a support that can be used in a modular configuration; any combination of such support structures or alternative stowable options are contemplated for use herein. Exemplary embodiments described herein are in terms of an antenna structure. However, exemplary embodiments may also be used for reflectors, solar collectors, etc. and remain within the scope of the instant application. To create a reflector or solar collector, exemplary embodiments may include a reflective surface coupled to the net mesh support structure described herein and/or may include a collector structure.

Any feature, component, configuration, and/or attribute described for any one example may be used in combination with any other example. Accordingly, any step, feature, component, configuration, and/or attribute may be used in any combination and remain within the scope of the instant description. Features may be removed, added, duplicated, integrated, subdivided, or otherwise recombined and remain within the scope of the instant disclosure. The exemplary embodiments described herein are provided for sake of example only. Therefore, any antenna, collector, support structure, or other configuration may be used with or without any of the components described herein.

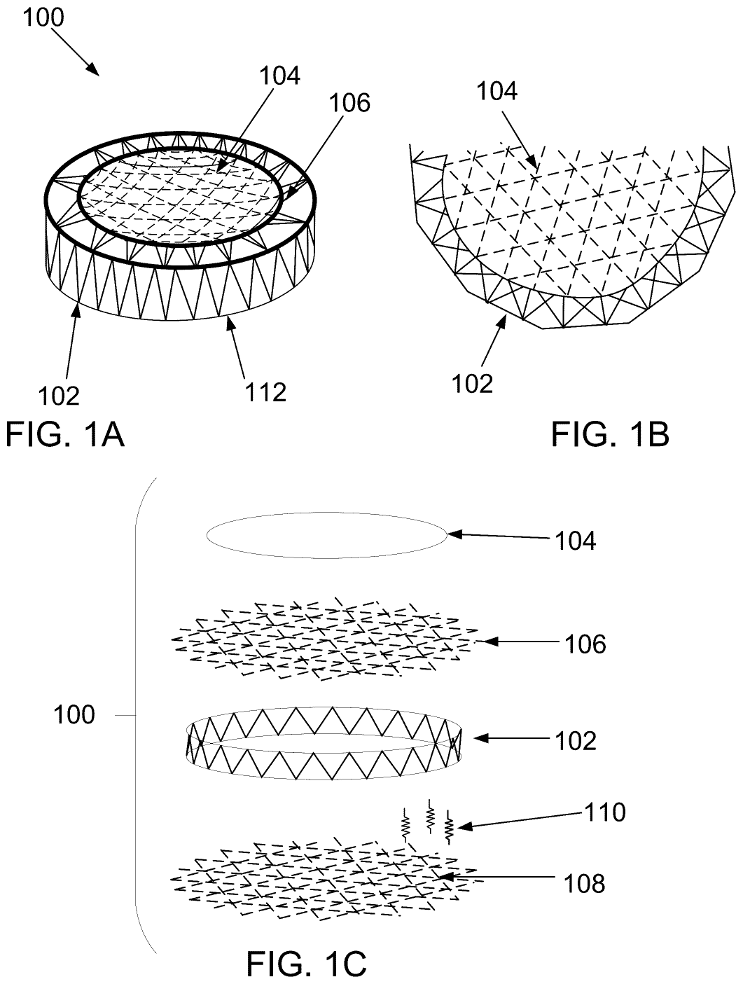

FIGS. 1A-1C illustrate an exemplary application using the support structure comprising exemplary embodiments of a truss frame according to embodiments described herein. FIG. 1C illustrates an exemplary component exploded view of the application of FIGS. 1A-1B. FIGS. 1A-1C illustrate an exemplary concept of a batten-less space deployable antenna. Other applications are also contemplated herein, such as reflectors, collectors, etc.

Large area reflectors in space are typically used as radiofrequency (RF) reflector antennas for communications or radar imaging, as well as for solar concentrators to produce photovoltaic power. A space deployable reflector antenna or solar concentrator is preferably lightweight and can be collapsible into a volume small enough to fit within the fairing of a rocket booster. Exemplary embodiments described herein include a low-weight, low-stowed-volume collapsible reflector antenna/concentrator perimeter truss support made in modular sub-structures for separate storage and deployment. The larger structure is explained herein with respect to FIGS. 1A-1C.

An exemplary structure 100 includes a perimeter truss 102 in this embodiment connected and supporting a reflector 104 and invert net domes 106, 108. The reflector 102 and invert domes 106, 108 that may be mated with the perimeter truss 102 are net mesh surfaces made of stiff non-conducting or conducting material. The reflector dome may be designed, such that under the proper tension it achieves a certain shape-a surface of revolution. The surface of revolution may be any surface of revolution, e.g., a paraboloid surface, spherical surface, etc., or substantial approximations thereto. The invert dome 108 may be a mirror image of the reflector dome 106 but does not have to be as accurately a mirror image of the reflector dome. Between the invert dome 108 and the reflector dome 106 are tension ties (force elements) 110 used to impart stress or tension to the mesh domes 106, 108. Thus, the reflector 104 and invert domes 106, 108 provide the anchor points for these tension ties. When properly tensioned, the reflector dome 106 contacts the reflector 104 and forces the reflector to take the same shape as the reflector dome 106.

In an exemplary embodiment, the reflector 104 may be a conducting mesh to create an antenna structure. The conducting mesh serves as the reflector of electromagnetic energy. For radio frequency (RF) applications, the conducting mesh may also be a thin film metalized with a few hundred Angstroms of vapor-deposited or sputtered aluminum or silver. For a solar concentrator application, the conducting mesh is replaced by a thin film metalized with a few hundred Angstroms of vapor-deposited or sputtered aluminum or silver. Thin films of other materials are also possible. The thin film may be a polyimide or a polyester material, for example. Other surface materials and structures are also contemplated herein. For example, mirrored surfaces may be used, including glass structures.

As illustrated in FIGS. 1A-1C, exemplary embodiments of a reflector 100 is provided. The reflector comprises a perimeter truss according to embodiments described herein. The perimeter truss 102 comprises longerons 112 as described herein. A reflective surface 106 is coupled to the perimeter truss 102. The support connections suspend the net perimeter (outer portion of 106) and provide tension on an outer edge of the reflector surface creating a tension drum. The perimeter truss 102 in this embodiment may couple to and support the reflector dome 106 and invert dome 108. The reflector dome 106 and invert dome 108 may comprise nets, mesh, cables, etc. Between the invert dome 108 and the reflector dome 106 may be tension ties 110 (force elements) used to impart stress or tension to the conducting mesh.

Although the perimeter truss 102 illustrated in FIGS. 1A, 1C are generally circular, the perimeter may be created from piece-wise straight section as illustrated in FIG. 1B.

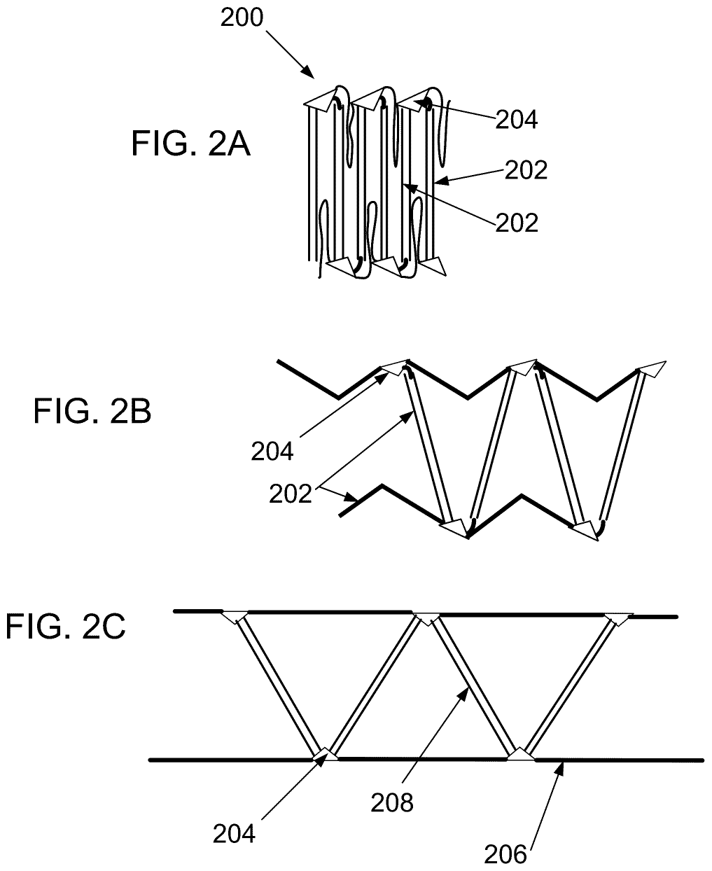

FIGS. 2A-2C illustrate an exemplary collapsed to expanded deployment sequence of an exemplary batten-less truss according to embodiments described herein that may be used for the truss structure described herein as a frame. In an exemplary embodiment, the truss may comprise a plurality of longerons and a plurality of diagonals. FIG. 2A illustrates an exemplary configuration in which the longerons are fully folded. Diagonals are illustrated in a vertical orientation. The illustrated diagonals in this example are not telescoping. FIG. 2B illustrates an exemplary configuration in which the longerons are partially folded. FIG. 2C illustrates an exemplary configuration in which the section of the truss is fully deployed. The truss is configured as a Warren Truss.

FIG. 2A shows how the batten-less perimeter truss is stowed in an exemplary configuration. As illustrated, the height of the folded/stowed configuration can be approximately the length of a diagonal member. The stowed height can be made shorter by using telescoping diagonals.

The exemplary truss 200 is configured from structural members 202 coupled by nodes 204. The structural members may comprise diagonals 208 and longerons 206. The longerons are configured to extend longitudinally along a length of the truss in a deployed configuration according to embodiments described herein. The diagonals are configured to extend across and along the truss in a deployed configuration, or at an angle with respect to the longerons in the deployed configuration according to embodiments described herein. The diagonal of the truss may be configured such that it is not perpendicular to the longerons in a deployed configuration.

In an exemplary embodiment, the diagonal members may be rigid members that are not configured to substantially deform during storage or deployment. The longerons may comprise deformable members that are configured to deform or have a different shape from the storage configuration to the deployed configuration. As used herein, a deformable member may comprise any configuration that deforms as described herein. For example, the deformable member may be flexible such that it flexes under the application of an outside force.

The terms rigid and flexible are used herein and are understood to be relative terms. Therefore, although it is understood that a rigid structure may still have some flexing under the application of a sufficient outside force, such absolute rigidity is not required. Instead, it will be understood by a person of skill in the art that the rigid structure is intended to generally maintain its shape during normal operation and for the intended purpose. The flexible structure is considered one that deforms along a length. The deformation may be through the application of a sufficient outside force without separating or breaking the structure so that it can be repositioned back into an original form. The deformable structure is considered one that deforms at a point or along a length. The deformable structure may therefore comprise joints, hinges, living hinges, flexible members, or a combination thereof.

Exemplary embodiments described herein comprise deformable structures that may still provide structural rigidity when the structure is fully deployed. For example, the deformable structure may be configured to deform under an application of a transverse or sheer force applied to the structure. The transverse force may be applied through the system architecture to deform the deformable structure and position the structure in a stowed configuration. The deformable structure may be configured to maintain its shape or remain rigid under the application of a compression or longitudinal force applied to the structure. The rigidity of the structure may be maintained in the normal use of the structure in its deployed configuration. The deformable structure may therefore comprise both deformable and rigid qualities depending on the direction of the applied forces.

Exemplary embodiments of the deformable structure may comprise any combination of configurations to achieve the deformable configuration described herein.

For example, exemplary embodiments of the deformable structure may comprise shape memory composites. These composites may be flexible and permit non-structured deformation under an application of an external force. The shape memory composite may also be frozen or retained in the deformed configuration, such as through a temperature transition. The shape memory composite may be configured to return to a remembered configuration. The remembered configuration may be through a passive or active transition. The shape memory composite may passively return to a remembered configuration for use in a deployed configuration by returning to a remembered configuration after the external force causing the deformation is removed. The shape memory composite may actively return to a remembered configuration when a transition condition is met, such as a change in a temperature or an application of an electrical current or removal of an outside force.

Exemplary embodiments of the deformable structures described herein may comprise elastomeric shape-memory carbon composite material. Exemplary embodiments may include other high-strain materials. Exemplary embodiments of the shape memory composite material may be used as structural elements such as the longeron members of the truss as described herein. The longerons may include structural fibers impregnated with elastomeric resin or a shape memory metal, e.g. Nitinol. The structural fiber may be made of carbon, fiberglass, aramid (e.g. Kevlar), Vectran, or combinations thereof. The longerons may be wrapped with a very thin piece of a membrane coated with SiO2 and/or Al2O3 for protection against atomic oxygen. The coatings may comprise about 50 Å of SiO2 or 35 Å of Al2O3. These coatings at these thicknesses have been shown to protect against degradation by atomic oxygen that are present at lower LEO altitudes.

Exemplary embodiments of the deformable structures described herein may comprise a thermally stable, shape-trainable, high-strain super elastic shape memory alloy material. Exemplary embodiments of the shape memory alloy material could be made of Nitinol or other alloys of Ni—Ti composite. Exemplary embodiments may include ternary alloy types of Ni—Ti that adds a third element for the purpose of making a more stable performance in shape setting, shape accuracy, and longevity in the space environment. The properties of the shape memory composite alloy can be tuned by controlling the relative amounts of alloy elements.

Exemplary embodiments of the deformable structures described herein may include rigid members comprising flexible or deformable sections. For example, the deformable structure may comprise rigid members coupled by a hinge. Exemplary hinges may be creased by sockets, rods, flexible material, or other known hinge structures.

The deformation may be unstructured or structured. The unstructured deformation may permit deformation based on the applied force to deform the structure. The unstructured deformation may permit deformation of the member along a length of the member in response to the applied force. The member may therefore deform into different shapes or configurations under different applied forces. The structured deformation may permit deformation in a known or pre-determined way. An example of a structured deformation is a hinge.

As illustrated in FIG. 2B to 2C, exemplary embodiments of the truss structure described herein comprises a plurality of structure members coupled together by a plurality of nodes. The connection between the structural member to the node permits the structural members connected at the node to be repositioned relative to each other to transition between a deployed configuration to a stowed configuration, and vice versa. As illustrated each node comprises at least two structural members—at least one diagonal structural member and at least one longeron structural member. Interior nodes may comprise at least four structural members—at least two diagonal members and at least two longeron members coupled to the same node. Therefore, a plurality of nodes may comprise at least four structural members extending therefrom.

In an exemplary embodiment, the diagonal structural members are rigid. The diagonal structural members may be rigid in the deployed configuration, stowed configuration, and transitions between the stowed and deployed configurations. In an exemplary embodiment, the diagonal structure member may be telescoping or non-telescoping.

In an exemplary embodiment, the longeron structural members are deformable. The longerons structural members may be deformable according to any configuration or embodiment described herein. The longeron structural members may be deformable in a transition from the stowed and deployed configuration as described herein. The longeron structural members may be rigid in the deployed configuration under expected and/or normal operating forces, such as compression forces applied to the longerons.

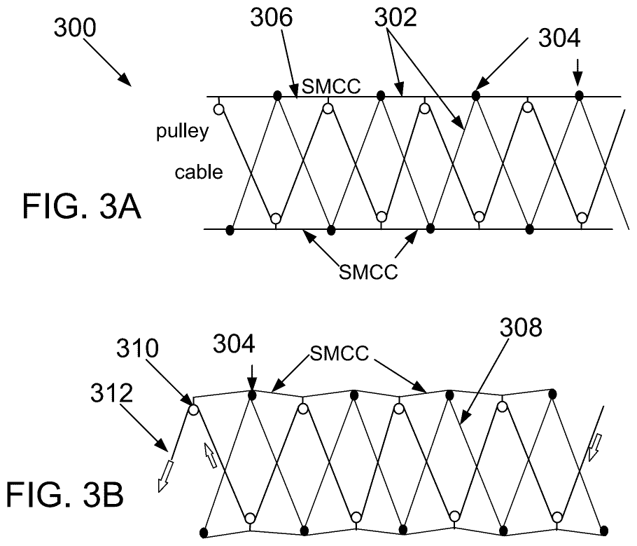

FIGS. 3A-3B illustrate an exemplary deployment system for use in the batten-less truss system according to embodiments described herein. FIGS. 3A-3B illustrates an exemplary structure in the shape of a Pantograph Truss.

Exemplary embodiments described herein may comprise a deployment system that may assist in the transition of the truss from a collapsed configuration to a deployed configuration or from the deployed configuration to a collapsed configuration.

An exemplary embodiment of a truss structure 300 comprises a plurality of structural members 302 and nodes 304. The structural members and nodes may comprise the structural members 202 or nodes 204 as described with respect to FIGS. 2A-2C or as described herein. The structural members 302 may comprise rigid and/or deformable structure as described herein. The longeron 306 as illustrated may be the deformable, while the diagonals 308 as illustrated may be rigid or non-deformable.

As illustrated, the longeron comprises a deformable member comprising a shape memory composite. The shape memory composite may be deformable under an application of an outside force. The shape memory composite may have a remembered configuration that it automatically or passively returns to after the outside force is removed. As illustrated, the remembered configuration is the linear configuration, and the deformed configuration is bent.

The truss system 300 illustrated herein also provides a deployment system. The deployment system may comprise a cable 312 and a plurality of pulleys 310.

The system may comprise a deployed configuration as illustrated in FIG. 3A. The cable may be positioned such that a neutral tension is applied to the cable, or in which the cable is not under tension so that the cable does not impose a sheer force on the longerons. Since the cable is not applying an outside force on the longerons, the longerons maintain their remembered configuration. The longerons are therefore straight and deployed.

The system comprises a stowed configuration in which the longerons are deformed and the structure is collapsed. FIG. 3B illustrates an exemplary transition from the deployed configuration toward the stowed configuration. A force is applied to the cable 312, as indicated by the arrow in FIG. 3B, putting the cable in tension. The cable is coupled to opposing sides of the truss and zigzags between adjacent longitudinal longerons on the same side of the truss and opposing longerons on opposite sides of the truss. For example, the cable 312 may be coupled to a first longeron on a first side of the truss, then to a first opposite longeron on a second side of the truss. The second side of the truss is opposite the first side of the truss. The first longeron may be longitudinally offset from the first opposite longeron. The cable may then be coupled to a second longeron on the first side of the truss. The second longeron may be longitudinally adjacent to the first longeron. The second longeron may be longitudinally offset from the first opposite longeron. The cable may then be coupled to a second opposite longeron. The second opposite longeron may be longitudinally adjacent to the first opposite longeron and may be longitudinally offset from the second longeron. The cable may repeat “n” longerons and “m” opposite longerons in this manner creating a zigzag between opposite sides of the truss, where n and m are integers. As a force is applied to the cable, a force is imposed on the deformable longeron members deforming the members toward a center of the truss or toward the opposite side of the truss. The system may therefore be configured to collapse and may stay in the stowed configuration by the continued application of tension on the cable. Once the tension is removed from the cable, the longerons may return to a remembered configuration and deploy to the deployed configuration.

Exemplary embodiments may include alternative or additional features that may be used as a stowage force for deforming the longerons and maintain the truss in a deformed configuration for stowage. Exemplary embodiments may also or alternatively use different or additional features within the overall structure or deployed device. For example, exemplary embodiments may include a tear away surface, removable retraction or stowage material or cords, an envelope, one or more antenna shapes, one or more sleeves or envelopes, one or more support infrastructures, a hub, one or more inflation mechanisms, housings, actuation devices, controllers, cables, pulleys, etc.

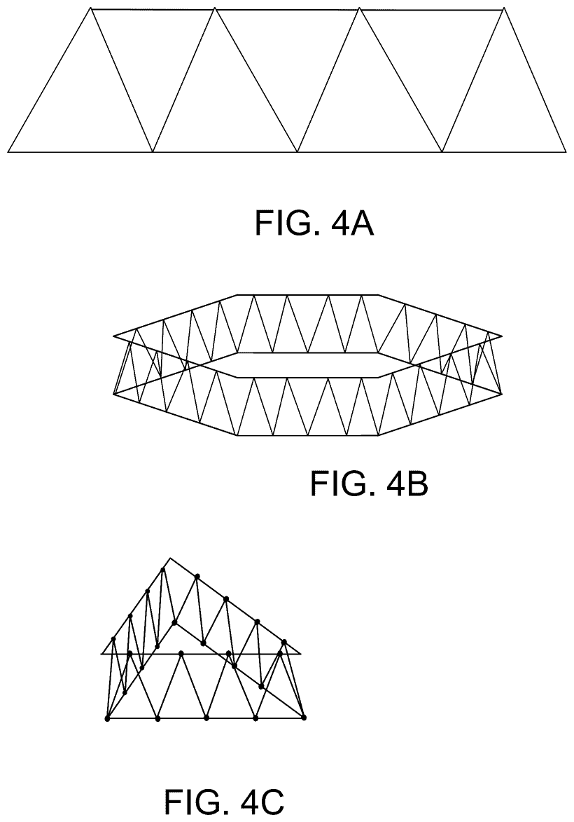

FIGS. 4A-4C illustrate an exemplary portion of a frame comprising exemplary embodiments of the batten-less truss according to embodiments described herein. FIG. 4A illustrates an exemplary portion of a structure in the shape of a Warren Perimeter Truss. The truss may comprise a plurality of longerons, and diagonals as described herein. The sections of the truss may be coupled together to create a closed form as illustrated in FIG. 4B. The closed form may define an outer frame for supporting the net mesh and reflective surfaces as described herein. As illustrated, the shape of the frame of the reflector and/or net mesh may comprise a plurality of piece-wise linear sections that are coupled together at an angle between adjacent structures. The piece-wise linear sections may be coupled together to approximate an overall circular structure according to embodiments described herein. As described more fully herein, the piecewise linear outer perimeter may define sections for the modular construction of embodiments described herein.

FIG. 4C illustrates an exemplary modular piece-wise frame made of a closed-form subframe that may be repeated in plurality to create a perimeter frame of a larger structure as described herein. As illustrated, the closed-form subframe may define a generally wedge-shaped structure. Each side of the wedge-shaped sub-frame may comprise a batten-less truss according to embodiments described herein. As illustrated, each side of the wedge-shaped sub-frame may be generally linear. The sides of the sub-frame may form a generally triangular shape or truncated triangle as illustrated and described with respect to other embodiments herein. A perimeter frame may comprise a plurality of sub-frames. Each sub-frame may be the same shape or may be different shapes or may include sets of different shapes as described herein. Sub-frames may be positioned next to each other to create a repeating pattern to form the larger overall structure. Although wedge sub-structures are shown and described herein for creating a generally circular overall larger structure, other sub-shapes and larger shapes may be made. For example, smaller square structures may be formed together to make a larger square or rectangular structure. Wedge sub-structures may be used to create ovoid, circular, stepwise circular, stepwise ovoid, oval, or other structure. As described herein, generally circular or an approximate shape is understood by a person of skill in the art to permit deviations from the desired shape as required or permitted by the design construction of the object, but which may still resemble the desired shape. Accordingly, a generally circular shape may be a closed form in that does not include curved edges, but instead piece-wise linear edges that are of approximately equal form to create a form that closely resembles or approximates a circle, especially when viewed at larger scales. The piece-wise linear sections may still approximate a circle because, for example, when put together, the resulting closed form may still be obtained and the overall surface area achieved approximates the performance of the closed form surface of a circle for the desired purpose of use as a reflector, collector, and/or antenna.

Exemplary embodiments described herein may be used as a design for a low weight, low stowed volume space deployable structure for antennas and concentrators. Exemplary embodiments described herein may comprise longerons and diagonals. In an exemplary embodiment, there are no transverse or batten members. Exemplary embodiments of the truss or frame described herein may be of any configuration, including those having batten members that extend perpendicular to the longerons between top and bottom longerons between separating adjacent diagonals. The battens may cut the equilateral triangles formed by the diagonals in half.

In an exemplary embodiment, the longerons and the diagonals can be made of rigid members such as steel, aluminum, or titanium. They can also or alternatively be made of composites of (a) carbon, (b) fiberglass, (b) Kevlar, (c) Vectran, (d) elastomeric shape memory carbon composite (SMCC), (e) rigidizable composite material made of Sub-T_{g} resin-impregnated structural fabric, (f) similar material, or (g) combinations thereof. The structural fabric for a Sub-T_{g} composite may be (a) carbon, (b) fiber glass, (c) Kevlar, (d) Vectran (e) similar material, or (f) combinations thereof. The longerons may be configured to bend, such as through a flexible material or with a hinge.

When the members are made of shape memory composite (SMCC) structural fabric, the resulting composite can be folded for packaging and when the restraint is removed, it deploys and seeks its memorized shape. When the longerons on the other hand are made of rigid members like steel, aluminum, titanium, composites of (a) carbon, (b) fiberglass, (c) Kevlar and (d) Vectran, there may be a locking hinge at its midpoint or along its length. The hinge may be used to bend the longeron at its midpoint or other desired length for stowing. When a shape memory carbon composite (SMCC) composite material is used, a hinge is not necessary since the material is pliant when a point load is applied normal to its length-the longeron can be bent at its midpoint or desired location. When the SMCC member is deployed, it can become a compression-tension member. Other shape memory composites may also be used and remain within the scope of the instant disclosure.

A Sub-T_{g} resin as describe herein may be a polymeric or polyurethane resin that becomes rigid when its temperature goes below its glass-transition temperature, T_{g}.

The shape memory composite material permits exemplary embodiments described herein to collapse under imposition of an outside force in a non-structured fashion. The collapsed configuration may therefore be dynamically determined based on the storage compartment or the outside force applied. For example, the shape memory composite may be flexible or deformable along a length when a force is applied. The shape memory composite, however, returns to a remembered configuration, once the force is removed. In other words, the remembered or biased configuration may be a deployed configuration in which the structure or frame is configured for use (antenna, collector, or other large area shape). In an exemplary embodiment, the shape memory composite may flex in any direction under application of an outside force. In an exemplary embodiment, the shape memory composite may flex at multiple locations along a length of the member or along an entire length of the member. In an exemplary embodiment, the shape memory composite may return to a remembered configuration, such as linear, circular, ovoid, curved, parabolic, helical, spiral, or other predefined shape when the outside force is removed.

An exemplary shape memory composite material includes a base material of one or more of carbon fiber, Vectran, Kevlar, fiberglass, glass fibers, plastics, and/or fiber metal. The base material comprises strands. The strands may be generally aligned along a length of the structure, may include one or more aligned arrangements, may be wound or helically positioned, may be woven, or any combination thereof. The shape memory composite material includes a matrix around and/or between the base material. The matrix may be silicone, urethane, or epoxy. Exemplary shape memory composite materials are described in co-owned patent application U.S. Patent Publication Number 2016/0288453, titled “Composite Material”. High strain material to permit deformation. High strain material generally has capability to strain beyond 3% and not enter the plastic deformation. In other words, the material may yield beyond 3%.

In an exemplary embodiment, the shape memory composite material has a volume fraction ratio of fiber-to-resin that may be controlled to achieve a desired shape memory retention even after long-term stowage in a folded/packaged state. An exemplary fiber-to-resin volume fraction ratio is from 52 to 65, namely 52% to 65% fiber or 48% to 35% matrix or resin. The average fiber-to-matrix ratio is about 58%. The fibers may be carbon, Kevlar, Vectran, nylon, or otherwise described herein and the resin may be urethane, silicone, or epoxy or otherwise described herein as the matrix.

Regardless of the truss structure used to create a frame of a reflective surface, an antenna reflector exceeding 100 meters in diameter will not fit inside the rocket fairing of any current or known rocket boosters. Exemplary embodiments described herein may therefore dis-aggregate the structure into many smaller substructures, each of which may fit into the rocket fairing or other desired stowage configuration. This is followed by the launch of the substructures into orbit where they are then assembled into a single very large antenna.

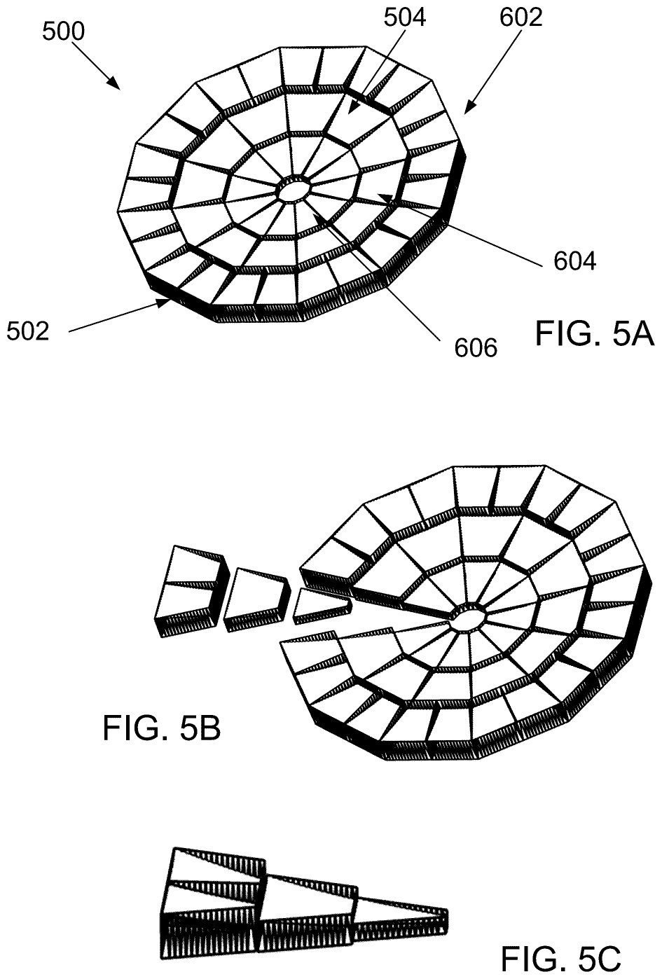

FIGS. 5A-5C illustrate an exemplary modular structure according to embodiments described herein. FIG. 5A illustrates an exemplary overall structure for use in a deployed and assembled configuration. FIG. 5B illustrates an exploded view in which select modular sub-assemblies are removed from the larger embodiment of FIG. 5A. FIG. 5C illustrates the removed modular sub-assembly along for closer inspection of its component parts. As illustrated, the overall reflective surface may be separated into modular sections. Some or all of the modular sections may be the same or some or all of the modular sections may be different. The modular structures may be coupled together to create the overall super structure.

FIG. 5A illustrates an exemplary super structure 500 such as a large collector, reflector, antenna, etc. The illustrated super structure 500 comprises a plurality of substructures 602, 604, 606. The super structure comprises a plurality of frames 502, such as the trusses described herein. The frames are configured to support a plurality of surfaces 504. The surfaces may be configured according to the desired application, such as a mesh, net, sheet, membrane, etc. that may be conductive and/or reflective as described herein.

As illustrated, the super structure may comprise a plurality of substructures. In an exemplary embodiment, the substructures are configured to be wedge shaped and may be triangular, and/or trapezoidal, such that the wedge is cut off. The substructures may be positioned adjacent to each other such that they define arcs of a circumferential superstructure. For large structures and/or when controlling the stowable size of a substructure, rings of substructures may be created. As illustrated, three sets of substructures are defined in which each substructure within its set is the same as the other substructures within the same set. However, the substructures between one set and another set may be different. The sets of substructures may be configured to form concentric rings so that a first set of substructures forms a first ring, a second set of substructures forms a second ring, and a third set of substructures forms a third ring. As illustrated, the first ring may be interior and concentric within the second ring and the third ring, and the second ring may be interior and concentric within the third ring. The respective heights of the different rings may be different between the rings. As seen in FIG. 5C, the height of the frame may be at least as large to correspond or support the vertical vector of the reflective surface, and/or overlap with an adjacent substructure in order for adjacent substructures to couple to each other. Therefore, the size of the form may be determined based on the surface of the respective substructure that is needed to be supported. The inner ring of substructures may therefore have a smaller height than the second ring, or next radially larger ring, which may have a smaller height than the outer-most ring of substructures. The lower end of each of the sets of substructures may be the same across the different sets of substructures. The common reference may be so that the respective substructures may be coupled together and/or aligned during the construction process. The respective heights of the different sets of substructures may have different base reference levels (i.e. “ground” or lower edge) so that a height of each of the different sets may be set according to the smallest need to support the surface for the given modular substructure and each ring or set of substructures may be offset with respect to adjacent sets or rings. As illustrated in FIG. 5C, the lower edge of a frame of each of the different sets of substructures is the same, while the upper edge of a frame of each of the different sets of substructures are different, with the inner sets are lower than the substructures on the outer ring or outer sets of substructures.

In an exemplary embodiment, a superstructure may comprise a plurality of substructures. A first substructure may be radially within a second substructure that may be radially within a third substructure. In an exemplary embodiment, the third substructure comprises two third substructures. In an exemplary embodiment, the first substructure, the second substructure, and the third substructure(s) define a wedge of the overall superstructure. A plurality of the wedges is then repeated circumferentially to form the superstructure.

In an exemplary embodiment, each substructure comprises a frame, a reflector, and a supporting infrastructure as described herein. For example, the frame may comprise a truss having longerons and diagonals as described herein. The reflector may be of any structure such as a mesh, conductive material, reflective material, membrane surface, sheet, etc. The supporting infrastructure may comprise a net mesh as described herein including a reflector dome, and invert dome, and force elements therebetween as described herein. As the modular portions of the structure may not comprise circular objects, but instead wedge shapes or other shapes for the modular pieces, a “dome” is simply used to equate the structure as described to other embodiments described herein. The support infrastructures do not necessarily have a domed shape as would be understood to a person of skill in the art. Instead, the shape of the dome will be defined by the frame and tension applied to the respective domes with the force elements. The dome may in other words be a support mesh and an inverted support mesh coupled together through force or tension elements so that the respective support meshes end up in a desired contour. The resulting domes (or portions thereof), may therefore be created as continuous surface, mesh structures, or other material structure in which a general surface shape can be approximated therefrom to be used in a desired application, such as an antenna, collector, reflector, etc.

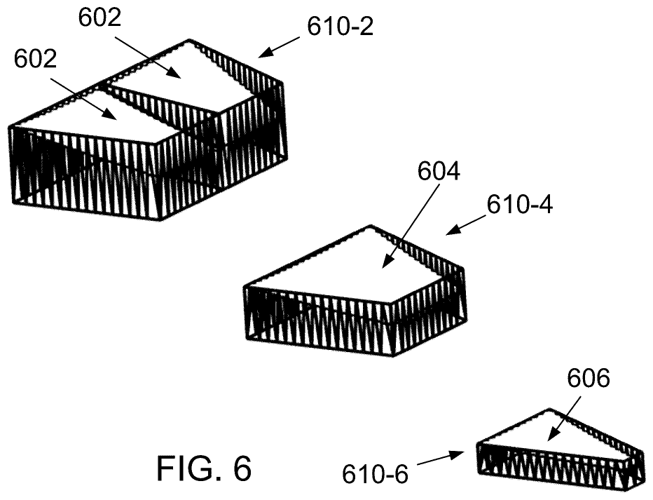

FIG. 6 illustrates an exemplary wedge portion of the modular construction comprising a first substructure 606 having a first frame 610-6, a second substructure 604 having a second frame 610-4, and a third substructure 602 having a third frame 610-2. The substructures are configured to be positioned radially outward from each other and couple together to create a wedge (or another portion) of the superstructure. As illustrated, each radially outer substructure may comprise the same number of substructures as a radially inner substructure or may comprise more substructures. As the substructures are configured to be positioned further radially out on the superstructure, the larger the substructure may become. Therefore, the substructure may be broken into smaller pieces or additional sub-structures in order to control the substructure size and corresponding stowage configuration. As illustrated, a first substructure and second substructure comprise the same number of substructures (one as illustrated), while the third substructure comprises two substructures to form a total radially outer substructure to the second substructure and cover the arc created by the second substructure. Each outer substructure may therefore comprise one, two, three, four, or more substructures to correspond to the same number or fewer inner substructures corresponding thereto. A corresponding substructure is understood to be the grouping of substructures configured to line up to define a part of the super structure that can be repeated about the superstructure and attached to each other.

As illustrated, each of the substructures comprises a wedge shape. Each substructure comprises a frame having two opposite frame sides that diverge (are closer together at one end than the other end). In an exemplary embodiment, such as for the radially innermost substructure, the two opposite frame sides may converge to an apex to define a true geometric wedge shape. In an exemplary embodiment, the frame may comprise two other opposite frame sides that extend between the two opposite frame sides. In an exemplary embodiment, the two other opposite frame sides are parallel to each other. In an exemplary embodiment, one of the two other opposite frame sides is shorter than a second of the two other opposite frame sides. If the two opposite frame sides come together, then the frame may comprise a single third frame side that extends between the two opposite frame sides on an end opposite the apex. Therefore, a frame may comprise a three-sided structure, a four-sided structure, or other shape. Each of the sides may be linear and/or may be curved. For example, the radial portions of the sub-structure may be linear, while the circumference sections of the larger structure may be curved. The curved structure may be created by using curved longerons between nodes.

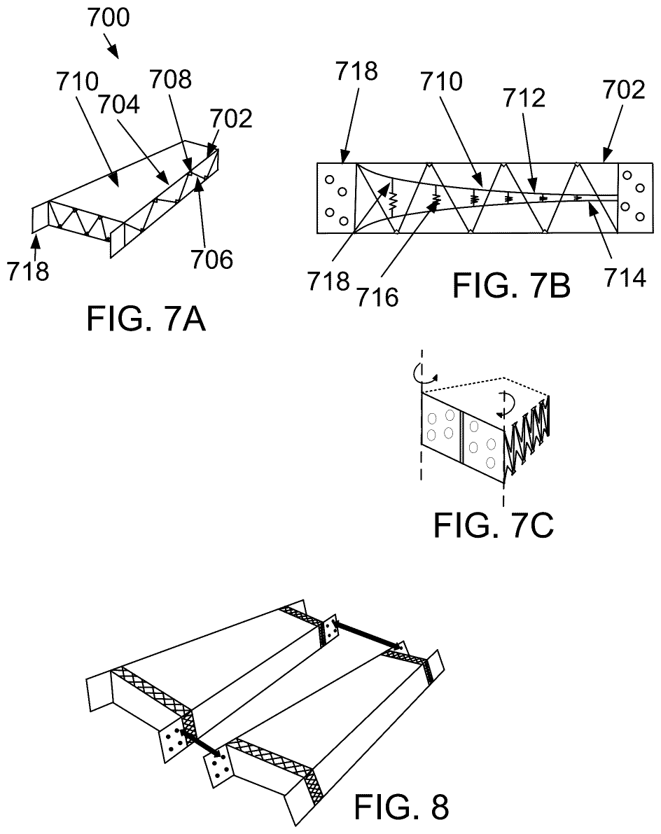

FIGS. 7A-7C illustrate different perspective views of elements of an exemplary substructure according to embodiments described herein. FIG. 7A shows the diagonals and the longerons. These elements may be designed to hinge and fold for packaging. FIG. 7B shows the RF reflective surface which may be parabolic, spherical, or flat. It also shows the invert dome onto which tension ties from the RF reflective surface are attached to keep the RF surface taut and tensioned. FIG. 7C is a notional packaging concept where the front and aft plates rotate as shown to achieve the compactness desired to fit within the available stowage space.

FIGS. 7A-7B illustrates an exemplary substructure 700 according to embodiments described herein. An exemplary substructure 700 comprises a frame. The frame may comprise longerons 702 and diagonals 706 in a truss configuration. In an exemplary embodiment a frame 702 may comprise multiple frame sections along different sides of the substructure. The frame sections may comprise longerons and diagonals. The longerons of the frame sections may extend generally linearly along a length to define two extensions (along top and bottom of a side of the substructure), with the diagonals traversing between the two extensions. In an exemplary embodiment, the longerons are configured to bend or deform to collapse the diagonals together, as generally illustrated in FIG. 7C. The longerons 704 and diagonals 706 are coupled together at nodes 708. As illustrated, a plurality of frame sections may be coupled together to create a frame. The frame may be a closed perimeter outer supporting structure for the reflective surface.

The exemplary substructure 700 may comprise a reflective surface 710. The reflective surface may be any surface (including mesh surfaces, solid surfaces, tessellated surfaces, etc.) as described herein. In an exemplary embodiment, the surface 710 is supported on a first supporting structure 712. The first supporting structure 712 may support the reflective surface 710 and define the same shape or structure as the reflective surface. The shape of the supporting structure 712 may be created through attachment to an inverted structure 714 using tensioning elements 716. By tightening or choosing a length and/or tension of tensioning elements 716, a force may be applied between the inverted structure 714 and the supporting structure 712 to create a desired shape. In an exemplary embodiment, the supporting structure 712 and inverted structure 714 are net meshes coupled together, such as with tensioning elements 716. Tension elements may be configured as elastic or extendable structures that act as a spring to impose a desired tension on the resulting surfaces or structures in a deployed configuration.

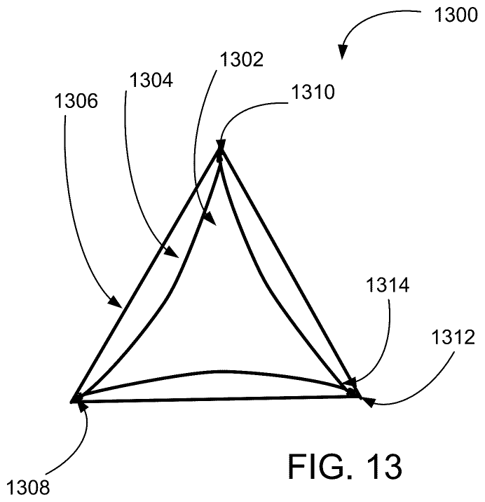

As illustrated in FIG. 7B, exemplary embodiments described herein support the individual reflective member 710 through a support structure. Exemplary embodiments of the support structure (102, 106, 108, 110) comprise flexible members for easy storage as described with respect to FIG. 1. In an exemplary embodiment, the support structure(s) may include one or more strings that are coupled together at nodes. When piece wise reflective members are used as described herein, such as those of FIGS. 12-13, the node 1312 of the support structures may be positioned adjacent the apex 1314 of the individual piece wise reflective member 1302. The nodes may be crossing, or knots, or other attachment of string together at a point. The nodes may create connection points for the individual piece wise reflective members.

Exemplary embodiments of the support structure comprise a mesh string frame 718. The string may be coupled to the outer frame 702 and extend in a pattern across an interior of the outer frame. When the outer frame is deployed, the mesh string frame is expanded and positioned in a desired configuration. The nodes of the mesh string may be used to position the reflective surface 710 is a desired shape by defining a desirable surface structure 712.

As illustrated, the modular substructures may comprise attachment panels 718. The attachment panels may be configured to attach adjacent substructures together. The adjacent substructures may be radially adjacent and/or circumferentially adjacent. As illustrated in FIG. 7C, the attachment panels 718 may be rotationally coupled to the frame 702 in order to collapse a substructure to a stowed configuration and extend the attachment panels in a deployed configuration.

FIG. 8 illustrates an embodiment of how two substructures of the large superstructure antenna may be joined together in space. The two substructures may be identical and joined together at the front and aft plates. The attach points on each plate may comprise mated surfaces to facilitate precision alignment between the adjacent substructures.

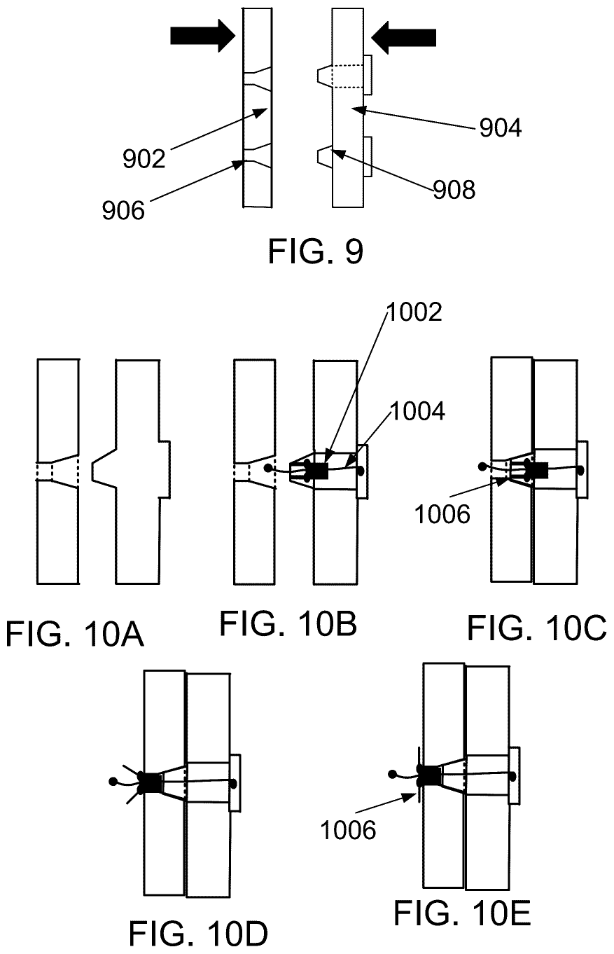

FIG. 9 illustrates an exemplary portion of the attachment panels according to an exemplary embodiment. A portion of one attachment panel of a first substructure and a portion of a second attachment panel of a second substructure are illustrated to show how an exemplary connection may be made between adjacent substructures. As described herein a first attachment panel 902 (that may be coupled to a first frame of a first substructure) may be configured to attach to a second attachment panel 904 (that may be coupled to a second frame of a second substructure). The first and second attachment panels 902, 904 may include mated structures or surfaces 906, 908 in order to align the attachment panels together.

In an exemplary embodiment, a conjugate conical structure may define the mated surfaces in order to improve the aligning accuracy of the in-space assembler robot. As illustrate a first attachment panel 902 may comprise a conical bore 906 in which the opening of the bore is wider (the diameter is greater), than the bore away from the opening. The opening may therefore taper from a larger diameter near the surface of the attachment panel adjacent the second attachment panel to be coupled to the first attachment panel and narrower (smaller diameter) away from the surface. The second attachment panel 904 may comprise a conical projection 908 that is configured to mate with the conical bore 906. The projection 908 may therefore be tapered from a larger diameter near the surface of the second attachment panel 904 and become narrower or have a smaller diameter toward the terminal end of the projection away from the second attachment panel 904 surface.

As illustrated, when the first attachment panel 902 is brought near the second attachment panel 904 (see arrows), the mated surfaces 906, 908 may bring the attachment panels into a desired alignment to improve precision between the panels. Therefore, even if there is an initial slight misalignment between the conical pin and conical slot, the tapered surface on both mated surfaces allows them to slide into each other. Once the plates are mated together, panels may be coupled together.

In an exemplary embodiment, the robotic claw maintains pressure and in one embodiment, may use ultrasonic welding to join the two plates together which may be made of metal, composite or other weldable material. Other attachments may also be used such as clamps, pins, rivets, etc.

FIGS. 10A-10E illustrate an exemplary attachment method according to embodiments described herein having mated surfaces and a locking device according to embodiments described herein.

In an exemplary embodiment, a locking device may be used to couple and retain the first attachment panel to the second attachment panel. As illustrated, the attachment panels comprise conical mated surfaces, i.e. an aperture and projection or pin and slot as described herein. The surfaces may be brought together and aligned as the mated surfaces contact each other and a compression force is applied between the attachment panels.

One of the attachment panels may comprise a locking device 1002. The locking device may comprise a configuration that may pass through the aperture of the other attachment panel and then expand on an exterior side of the other attachment panel away from the attachment panel having the locking device. The locking device 1002 may be tethered 1004 or coupled to the attachment panel and may be configured to compress the other attachment panel toward the attachment panel. As illustrated, the locking device has a deployable structure. The deployable structure may have a first configuration that may fit through the aperture of the other attachment panel. The locking device 1002 may comprise arms or protections 1006 that extend longitudinally through the aperture for passing through the aperture. Once through the aperture, the deployable structure may have a biased configuration in which the cross section of the deployable structure is larger than a diameter of the aperture of the other attachment panel so that the locking device cannot re-enter the aperture of the other attachment device. The locking device may comprise an elastic tether 1004 or other compressible or spring structure so that the locking device applies a pressure to the other attachment panel to retain the other attachment panel in a secure position relative to the attachment panel. In an exemplary embodiment, the locking device may simply be crimped or otherwise attached to the tether when pressure is being applied on the tether and the panels brought together with the locking device positioned against the exterior surface of the other attachment panel, similar to a cord lock of a draw string. The cord lock may include stoppers, spring clasp, cord toggle, or the like.

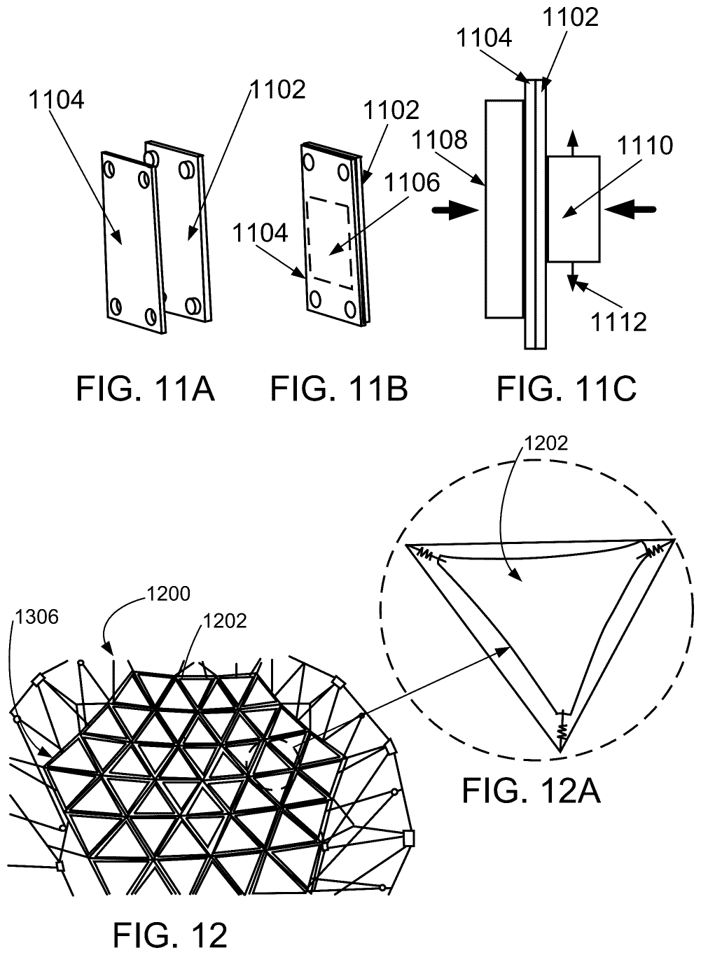

FIGS. 11A-11C illustrate an alternative attachment method in which the attachment panels 1102, 1104 may be welded. As illustrated the attachment panels may have the same or different mated surfaces. The attachment surfaces may be brought together as illustrated in FIG. 11B, the surfaces may then be welded together (indicated by the enclosed dashed area 1106 of FIG. 11B). The attachment panels 1102, 1104 may be held together, such as with a clamping force (as illustrated as applied between an anvil 1108 and welding tip or horn 1110) so that the attachment panels are maintained in a desired position when coupled together.

FIG. 12 illustrates an exemplary tessellated reflective surface of an exemplary solar collector according to embodiments described herein with FIG. 12A being an expanded view of a single reflective portion of the reflective surface. In an exemplary embodiment, the reflective surface 1200 comprises a plurality of individual piece wise members 1202. Ultrasonic vibration (as illustrated with arrows 1112) may then be applied to weld the surfaces together.

In an exemplary embodiment, the reflective surface 104, 710 may be tessellated. The reflective surface 1200 may therefore comprise individual piece wise members 1202 that may be shaped, oriented, and positioned to approximate a desired shape of a reflective structure. In an exemplary embodiment, the individual piece wise members 1202 may be flat. The individual piece wise members 1202 may also be curved about one or two axis or have any desired shape. The piece wise members 1202 may comprise shape memory material so that they may be flat in a stored configuration and/or curved in a deployed configuration.

FIG. 13 illustrates an exemplary individual piece wise reflective member 1300 within a portion of the support structure of the tessellated reflective surface according to embodiments described herein. The exemplary piece wise reflective member may be supported by the support structure as described herein. For example, a first supporting structure 712 may comprise a plurality of mesh strings 1306 that are configured to support a piecewise reflective surface 1302. The first supporting structure may be configured based on the positioning of the mesh strings to support a plurality of piecewise reflective surfaces.

In an exemplary embodiment, the reflective surface is tessellated into individual piece wise reflective members. The exemplary tessellated piece 1300 of the overall reflective surface may include the piece wise reflective member 1302 and a support structure 1306. The support structure 1306 may be configured to put the piece wise reflective surface 1302 under tension through connectors 1308 between the piece wise member 1302 to the support structure 1306. The tension of the piece wise reflective member may reduce deformations of the surface and improve solar collection.

As illustrated, the piece wise reflective member 1302 may comprise a geometric shape. As illustrated, the piece wise reflective member 1302 is generally triangular with three apexes. Other shapes are also contemplated herein including, square, rectangular, pentagon, hexagon, etc. In an exemplary embodiment, the piece wise reflective member 1302 comprises a plurality of apexes in which the apex of the individual reflective member is coupled through a connector 1308 from the piece wise reflective member 1302 to the support structure 1306. In an exemplary embodiment, the connection may include a spring 1310 or other tensioning element in order to put the individual reflective member 1302 under tension within the support structure in the deployed configuration.

As illustrated in FIG. 13, an exemplary piece wise reflective member may include a metalized membrane in a generally triangular shape. The edges of the metalized membrane may be curved inward. The metalized membrane may create the reflective surface for use as a portion of the antenna, collector, mirror, reflector, or other surface as described herein. The metalized membrane may couple to a mesh support structure at the apex of the membrane. The metalized membrane may be supported by a mesh created by strings criss-crossing or knotted together. The mesh strings may be on different sides of the metalized membrane.

As illustrated, the perimeter edges 1304 of the individual piece wise members 1302 may be curved. In an exemplary embodiment, the edge 1304 is shaped as a catenary curved edge. Other configurations may include straight edges. An exemplary embodiment of the piece wise member in a triangular shape having catenary edges may be configured to permit attachment at the corners (apex) of each triangle to result in a flat reflective surface. A spring may be connected at one or more corner (apex) of the triangle to the support structure to tension the reflective triangle element when the solar collector is fully deployed. In an exemplary embodiment, only a single apex of the piece wise reflective member has a tensioning member coupled thereto, such as with a spring. The spring may be from a wound structure and/or from a longitudinal elastic extendable structure and/or from another structure configured to change length and having a biasing force to return the structure to a shortened configuration when elongated.

Exemplary embodiments may include reflective membranes as the individual reflective members. The reflective members may be membrane gores that are flexible. The membranes may be used to reduce size and wight of the overall solar collector, reflector, or antenna. Exemplary embodiments may also or alternatively use rigid reflective members. The rigid reflective members may be supported through the support structure as described herein. The rigid reflective members may or may not be under tension and/or may or may not use tensioning elements, such as springs to apply additional tension to the reflective member. The rigid reflective members may define a surface shape that is flat and/or curved. The surface shape may be retained regardless of the tension put on the rigid reflective member, at least for the tension applications contemplated by the support structure.

In spite of the various technology advances in space-based communications, remote sensing, astronomical observations, and ISR (Intelligence, Surveillance, and Reconnaissance), an increase in the antenna aperture size continues to be an important parameter in achieving increased performance. Current space-based systems are mainly limited, not by payload mass, but by stowed volume. What is needed is high deployment reliability, low-cost, lightweight and low stowed volume antenna structure that can enable efficient stowage capability. This capability can potentially allow two or more full-sized antennas per launch vehicle, translating to lower overall cost. It is noted that, in general, it is the stowage efficiency rather than mass that determines the overall launch cost. The reason is because the requirement of a larger fairing most often moves one to a booster that is one to two levels up in size with launch costs rising by tens to hundreds of million dollars.

In an exemplary embodiment, the reflective surface described herein may be configured as an antenna. The reflector surface may be gold-coated molybdenum mesh or aluminized polyimide material (Kapton). There may be an invert dome below the reflector surface that comprises the same triangular-hexagonal net structure as the reflector dome. The invert dome is used to attach the vertical ties used to tension the reflector surface. The reflector-dome combination with the invert dome may form a tension drum. As long as tension is maintained, the tension drum is barely affected by what happens to the outer perimeter truss.

Exemplary embodiments of the antenna described herein may comprise a very large aperture antenna comprising sub-truss elements that are joined together as shown and described herein. This configuration with a very large aperture diameter may be partitioned into a number of smaller sub-truss structure elements as shown and described herein. The sub-truss structures may be identical to each other for economy and for simplicity of the associated deployment and operation of in-space assembly. The perimeter of the now non-circular sub-aperture uses an exemplary perimeter truss configuration, namely rigid diagonals and foldable/packageable longerons made of deformable structures (whether shape memory, joints, pivots, or other collapsible structure).

Exemplary embodiments described herein may include methods of joining two sub-truss elements of the large diameter antenna structure in space. The two sub-elements may be identical and are joined together at the front and aft attachment plates. The exemplary four attach points on each plate (but any number of attachment points may be used) may be conjugate conical structures. As shown and described herein, aligning effort by a space robot may be reduced since even if there is some misalignment initially, the conical wedge allows each to slide into each other. Once the plates are mated together, the robotic claw maintains pressure and activates ultrasonic welding of the plates. The plates may be made with either carbon epoxy composite of fiberglass epoxy. Ultrasonic welding works on epoxy carbon or epoxy glass composites and ground tests show excellent weld bonding. In one method of ultrasonic welding, an adhesive sheet may be placed between the plates to be welded. When the ultrasonic frequency signal is applied, the minute high frequency ultrasonic vibration of the surface melts the adhesive sheet and bonds the two surfaces together. The adhesive cures quickly after the ultrasonic signal is turned off. For additional safety, the clamping force provided by the robotic claw may not be removed until full cure.

The use of ultrasonic welding is a satisfactory choice since it will allow the joining of two surfaces without the need to bring to orbit additional bolts, rivets, welding wire, power system for the electromagnets, or equipment to apply. Along with this, ultrasonic welding has been shown to join a wide range of materials which include carbon of glass fiber reinforced plastics/epoxy and dissimilar materials.

One concern is the strength of the weld. This can be increased by using a conjugate pin-slot to distribute the stress and to remove rotational degrees of freedom as well as two of the three translational degrees of freedom. The ultrasonic weld constrains the last degree of freedom which is normal to the joining surface. A second concern is that the pin and slot may restrain the vibration needed to join the materials. This can be addressed with incorporating the tolerance needed for the surface to vibrate inside the pin and slot design.

In addition to joining the surfaces using ultrasonic welding, one could add redundancy by providing additional mechanical clamping as shown and described herein. In an exemplary embodiment, the surface with a male conjugate pin may have contained therein a cylindrical block with two spring-loaded plates. After the two surfaces intimately touch and weld, the robot clamps onto the tether to the cylindrical block and pulls it until the cylindrical block and attached spring loaded plates are moved to an exterior surface of the attachment plates. When the spring-loaded plates clear the slot, the plates rotate ninety degrees to their deployment position. The spool in the block may be spring loaded and maintains the mechanical clamping force. The attachment methods may be used alone or in combination to increase the attachment between the panels described herein.

In an exemplary embodiment, to address micrometeoroid damage, the outer perimeter of each sub-structure may be covered with a thin sheet of Kevlar or Vectran tarps. These tarps may act as Whipple shields against micrometeoroid puncture. The tarp may be “removed” to show the rigid diagonals (made of carbon epoxy or fiberglass epoxy). In an exemplary embodiment, each substructure may fold in the same way for storage and deployment.

Depending on the diameter size of the antenna, it may have to also be partitioned along the radial line. Instead of one substructure which spans a length of half the diameter, this length may have to be further divvied up into two or three (or more substructures). This configuration is shown and described herein including all sub-truss elements joined together to form the ultra large diameter antenna, see, for example, FIG. 5A. It is noted that along the diameter, there are three substructures that are repeated on opposing sides of the center of the antenna, i.e. mirrored about the center of the antenna for a total of six substructures spanning the entire diameter of the antenna. These radial substructures may be joined together as illustrated and described herein.

The use of a dis-aggregation method described herein enables the reduction of the packaging volume of each substructure allowing each to fit within the fairing volume of currently available rocket boosters, or other desired stowage volume. Once these substructures are in orbit, they can then be gathered and assembled in-situ (in space) using any space assembly methods, including people and/or a space assembler robot.

Exemplary embodiments of the system described herein include a deployable structure, comprising: a plurality of modular deployable structures, wherein each of the plurality of modular deployable structures are separate structures from each of another of the plurality of modular deployable structures.

The deployable structure may have each of the plurality of modular deployable structures comprising an attachment feature configured to attach with the attachment feature of another of the plurality of modular deployable structures.

The deployable structure may have the attachment feature having a mated surface configured to correspond to another mated surface of another attachment feature of the another of the plurality of modular deployable structures, wherein the mated surface and the another mated surface comprises corresponding tapered cylindrical surface, wherein a relative size of the mated surface and the another mated surface permits ultrasonic welding of the attachment feature to the attachment feature of another of the plurality of modular deployable structures. In an exemplary embodiment, the respective size and shape may be such to permit the desired vibration of the respective surfaces to achieve a desired weld from application of ultrasonic vibrations to the surfaces. The respective size and shape of the mated surface may be so that the surfaces are brought together in a desired relative position for attaching one surface to another surface is a desired and/or predefined configuration and/or orientation.

The deployable structure may have each of the modular deployable structures having a perimeter frame, wherein the perimeter frame is collapsible and expandable between a stowed configuration having a reduced volume and a deployed configuration having an expanded volume relative to the reduced volume, a support structure coupled to the perimeter frame, and a surface supported by the support structure.

The deployable structure may have the frame of each of the modular deployable structures comprising at least three sides, where two opposing sides of the at least three sides are tapered to create a narrower end and a wider end between the two opposing sides, and a third side extending between the two opposing sides at the wider end between the two opposing sides, wherein the frame defines a closed loop structure. The two opposing sides may directly couple to each other on the narrower end of the two opposing sides or may be coupled through a fourth side.

The deployable structure may have the frame of each of the modular deployable structures having a plurality of longerons, a plurality of diagonals, and nodes connecting adjacent longerons and diagonals, wherein the longerons are flexible to deform in the stowed configuration and extend in the deployed configuration.

The deployable structure may have the plurality of modular deployable structures comprises a first set of modular deployable structures wherein each of the first set of modular deployable structures have a same configuration. The first set of modular deployable structures may make up all of the modular deployable structures or only a subset of the plurality of modular deployable structures.

The deployable structure may have a first side of the two opposing sides of each of the first set of modular deployable structures couple to a second side of the two opposing sides of another one of the plurality of the first set of modular deployable structures, wherein the first set of modular deployable structures are configured to attach together to form a first ring. The first set of modular deployable structures may couple side by side to each along the two opposing sides of the modular deployable structure.

The deployable structure may have the plurality of modular deployable structures comprising a second set of modular deployable structures, wherein each of the second set of modular deployable structures have a second same configuration. The second same configuration of the second set of modular deployable structures may be different than the same configuration of the first set of deployable structures. The second set of modular deployable structures may be configured to couple together to form a second ring, wherein the second ring sized and shaped relative to the first ring size and shape to be concentric with and positioned radially outside the first ring.

The deployable structure may have the plurality of modular deployable structures configured to attach and position each of the surfaces of the plurality of modular deployable structures to form an antenna surface of the deployable structure.

The deployable structure may have each of the plurality of modular deployable structures defining a closed loop frame expandable between a stowed configuration and a deployed configuration, where the stowed configuration has a smaller volume than the deployed configuration, a support structure coupled to the frame, and a surface supported by the support structure, wherein the surface comprises a portion of an antenna surface, a portion of a reflective surface, or a portion of a collector surface, wherein the antenna surface, reflective surface, or collector surface is defined by the individual surfaces of the plurality of modular deployable structures coupled together in the deployed configuration.

Exemplary embodiments described herein may include a method of deploying a deployable structure, comprising launching a plurality of modular deployable structures to a deployment location; coupling the plurality of modular deployable structures together to form the deployable structure; and deploying the deployable structure from a collapsed configuration to a deployed configuration.

The method of deploying the deployable structure may include the launch of the plurality of modular deployable structures including storing each of the plurality of modular deployable structures in separate payloads of one or more space craft to move the plurality of modular deployable structures from earth to the deployment location in space.

The method of deploying the deployable structure may also or alternatively include using a robot to position each of the plurality of modular deployable structures relative to each other and attaching the plurality of modular deployable structures together.

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

Conditional language used herein, such as, among others, “can,” “could,” “might,” “may,” “e.g.,” and the like, unless specifically stated otherwise, or otherwise understood within the context as used, is generally intended to convey that certain embodiments include certain features, elements and/or states. However, such language also includes embodiments in which the feature, element or state is not present as well. Thus, such conditional language is not generally intended to imply that features, elements and/or states are in any way required for one or more embodiments or that one or more embodiments necessarily exclude components not described by another embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item.

As used herein, the terms “about,” “substantially,” or “approximately” for any numerical values, ranges, shapes, distances, relative relationships, etc. indicate a suitable dimensional tolerance that allows the part or collection of components to function for its intended purpose as described herein. Numerical ranges may also be provided herein. Unless otherwise indicated, each range is intended to include the endpoints, and any quantity within the provided range. Therefore, a range of 2-4, includes 2, 3, 4, and any subdivision between 2 and 4, such as 2.1, 2.01, and 2.001. The range also encompasses any combination of ranges, such that 2-4 includes 2-3 and 3-4.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims. Specifically, exemplary components are described herein. Any combination of these components may be used in any combination. For example, any component, feature, step or part may be integrated, separated, sub-divided, removed, duplicated, added, or used in any combination and remain within the scope of the present disclosure. Embodiments are exemplary only, and provide an illustrative combination of features, but are not limited thereto.

The invention claimed is:

1. A deployable structure, comprising:
a plurality of modular deployable structures, wherein each of the plurality of modular deployable structures are separate structures from each of another of the plurality of modular deployable structures.

2. The deployable structure of claim 1, wherein each of the plurality of modular deployable structures comprises an attachment feature configured to attach with the attachment feature of another of the plurality of modular deployable structures.

3. The deployable structure of claim 2, wherein the attachment feature comprises a mated surface configured to correspond to another mated surface of another attachment feature of the another of the plurality of modular deployable structures, wherein the mated surface and the another mated surface comprises corresponding tapered cylindrical surface, wherein a relative size of the mated surface and the another mated surface permits ultrasonic welding of the attachment feature to the attachment feature of another of the plurality of modular deployable structures.

4. The deployable structure of claim 1, wherein each of the modular deployable structures comprises a perimeter frame, wherein the perimeter frame is collapsible and expandable between a stowed configuration having a reduced volume and a deployed configuration having an expanded volume relative to the reduced volume, a support structure coupled to the perimeter frame, and a surface supported by the support structure.

5. The deployable structure of claim 4, wherein the frame of each of the modular deployable structures comprises at least three sides, where two opposing sides of the at least three sides are tapered to create a narrower end and a wider end between the two opposing sides, and a third side extending between the two opposing sides at the wider end between the two opposing sides, wherein the frame defines a closed loop structure.

6. The deployable structure of claim 5, wherein the frame of each of the modular deployable structures comprises a plurality of longerons, a plurality of diagonals, and nodes connecting adjacent longerons and diagonals, wherein the longerons are flexible to deform in the stowed configuration and extend in the deployed configuration.

7. The deployable structure of claim 6, wherein the plurality of modular deployable structures comprises a first set of modular deployable structures wherein each of the first set of modular deployable structures have a same configuration.

8. The deployable structure of claim 7, wherein a first side of the two opposing sides of each of the first set of modular deployable structures couple to a second side of the two opposing sides of another one of the plurality of the first set of modular deployable structures, wherein the first set of modular deployable structures are configured to attach together to form a first ring.

9. The deployable structure of claim 8, wherein the plurality of modular deployable structures comprises a second set of modular deployable structures, wherein each of the second set of modular deployable structures have a second same configuration.

10. The deployable structure of claim 9, wherein the second set of modular deployable structures are configured to couple together to form a second ring, wherein the second ring sized and shaped relative to the first ring size and shape to be concentric with and positioned radially outside the first ring.

11. The deployable structure of claim 10, wherein the plurality of modular deployable structures are configured to attach together and position each of the surfaces of the plurality of modular deployable structures to form an antenna surface of the deployable structure.

12. The deployable structure of claim 1, wherein each of the plurality of modular deployable structures comprises a closed loop frame expandable between a stowed configuration and a deployed configuration, where the stowed configuration has a smaller volume than the deployed configuration, a support structure coupled to the frame, and a surface supported by the support structure, wherein the surface comprises a portion of an antenna surface, a portion of a reflective surface, or a portion of a collector surface, wherein the antenna surface, reflective surface, or collector surface is defined by the individual surfaces of the plurality of modular deployable structures coupled together in the deployed configuration.

13. A method of deploying a deployable structure, comprising:
launching a plurality of modular deployable structures to a deployment location;
coupling the plurality of modular deployable structures together to form the deployable structure; and
deploying the deployable structure from a collapsed configuration to a deployed configuration.

14. The method of deploying the deployable structure of claim 13, wherein the launch of the plurality of modular deployable structures includes storing each of the plurality of modular deployable structures in separate payloads of one or more space craft to move the plurality of modular deployable structures from earth to the deployment location in space.

15. The method of deploying the deployable structure of claim 13, further comprising:
using a robot to position each of the plurality of modular deployable structures relative to each other and attaching the plurality of modular deployable structures together.
